(19) United States
(12) Patent Application Publication
(10) Pub. No.: US 2011/0059663 A1
(43) Pub. Date: Mar. 10, 2011

(54) ADVANCED FOIL DESIGN METHOD AND STRUCTURE FOR MULTI SPEEDS

(75) Inventors: Jeng-Lih Hwang, Tamshui (TW); Ching-Yeh Hsin, Tamshui (TW); Shang-Sheng Chin, Tamshui (TW)

(73) Assignee: UNITED SHIP DESIGN AND DEVELOPMENT CENTER, Tamshui (TW)

(21) Appl. No.: 12/554,209

(22) Filed: Sep. 4, 2009

(51) Int. Cl. B63H 1/14; B63H 1/26; G06F 17/50

(52) U.S. Cl. 440/49; 416/90 A; 416/223 R; 703/1

(57) ABSTRACT

Advanced foil design method and structure for multi speeds mainly adds a constraint according to a needed pressure distribution of the advanced foil after building an advanced foil environment. Thence, a step of optimization could be applied for analyzing the advanced foil by flow characteristics to achieve a shaped profile, so that a weight calculation weighted calculation would be further operated base on a proportion of the advanced coil applied to multi speeds. Accordingly, a preferable profile of the advanced foil and the environment parameter combination can be obtained to enhance a higher operative efficiency with the preferred benefit of the Supercavitating propeller while applied to a higher speed and with the profit of a stable competence while applied to a lower speed.

### BACKGROUND OF THE INVENTION

1. Field of the Invention

The present invention relates to a design method of a propeller of ships, in particular to an advanced foil design method and structure for multi speeds.

2. Description of the Related Art

Generally, a conventional propeller of a ship predominantly adopts NACA series, KCA series, or Supercavitating series. Referring to FIG. 1, while the propellers are speeded up, the efficiencies performed by the propeller of the NACA and KCA series would rapidly decrease. Whereas, when the propellers are applied in a high speed, a high efficiency performed by the propeller of the Supercavitating series can be preferably achieved. On the other hand, when the propeller of the Supercavitating series is applied to a lower speed, the efficiency performed thereof would be much lower than those of the NACA and KCA series. Thus, the propellers above-mentioned could only be applied to a certain scope of speed to achieve their preferred efficiencies. If the propellers are applied beyond their loaded speeds, the corresponding efficiencies thereof would be greatly lessened.

### SUMMARY OF THE INVENTION

Accordingly, when a ship navigates below thirty knots at a low speed, the propeller herein would mainly adopt the NACA or KCA series. Whereas, when a ship navigates at a higher speed above thirty knots, a Supercavitating series propeller would be mostly adopted. Hence, if a ship mainly navigates at a speed over thirty knots, the propeller thereof would usually adopt a propeller of the Supercavitating series. However, the ship in reality usually navigates at a speed from twenty to forty knots. Therefore, if the propellers of the NACA or KCA series are adopted at the speed over thirty knots, the efficiency of the propeller would be greatly decreased in view of the Cavitation, and the surface of the propeller would accordingly generate bubbles because of the Cavitation, hence resulting in vibrations of the hull. Oppositely, if the propeller adopts the Supercavitating series, the ship would be unable to operate at a low speed because of the poor efficiency. As a result, the present invention is to combine the strengths of the propeller of the NACA, KCA, and Supercavitating series to obtain a propeller that can be applied to multi speeds.

It is an object of the present invention to provide an advanced foil design method and structure for multi speeds. The design method of the present invention mainly comprises steps of building an advanced foil environment, processing an optimization, analyzing flow characteristics, building an advanced foil, and calculating the weighting. Wherein, after building the advanced foil environment, a constraint would be accordingly added base on a pressure distribution condition of the advanced foil, and the optimization can be thence proceeded. Subsequently, the optimized group would be analyzed via flow characteristics so as to continue the weighted calculation according to the proportion of the advanced foil applied to multi speeds. By doing so, a best environment parameter combination and the corresponding profile of the advanced foil can be selected.

The present invention provides an advanced foil design method and structure for multi speeds. The structure made in conformity with the design method of the present invention would provide a higher operative efficiency for multi speeds than that of the prior art, which also possesses the property of the Supercavitating propeller operated in high speeds and the advantage of the NACA as well as the KCA series propeller worked at lower speeds. Therefore, a higher efficiency of the propeller can be achieved no matter the ship navigates at a lower speed or at a higher speed. Further, during the step of optimization proceeding to building the advanced foil, the numerical analysis and the foil inverse computational techniques adopted herein would assist multi operation points to attain the preferred efficiency so as to increase the benefit of building the advanced foil.

### BRIEF DESCRIPTION OF THE DRAWINGS

FIG. 1 is a chart showing different conventional propellers applied in divergent speeds and the corresponding efficiencies;

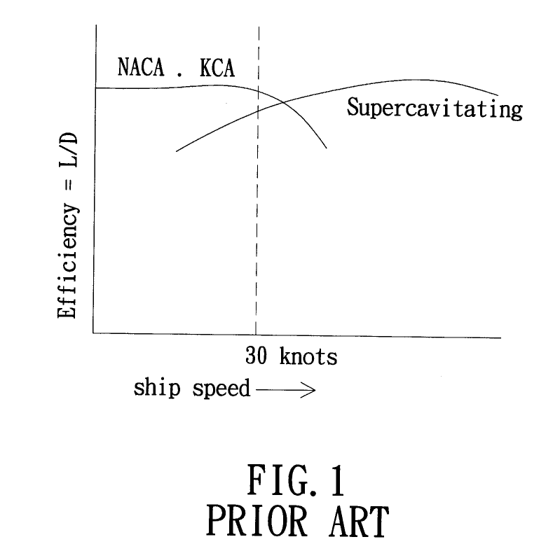

FIG. 2 is a sectional view showing the structure of the advanced foil of the present invention;

FIG. 3 is a flow chart showing the design method of the advanced foil of the present invention;

FIG. 4 is a chart showing the lift coefficient of the advanced foil of the present invention applied to different speeds;

FIG. 5 is a chart showing the advanced foil group of the present invention adopting the pressure inverse computation;

FIG. 6 is a table list showing the lift coefficient, drag coefficient, and efficiency after weighted calculation;

FIG. 7 is a chart showing the selected preferred advanced foil after weighted calculation;

FIG. 8(A) is a chart showing the pressure distribution of the advanced foil applied at thirty knots;

FIG. 8(B) is a chart showing the pressure distribution of the advanced foil applied at forty knots; and

FIG. 9 is an analysis showing the advanced foil undertaking Caviation.

### DETAILED DESCRIPTION OF THE PREFERRED EMBODIMENTS

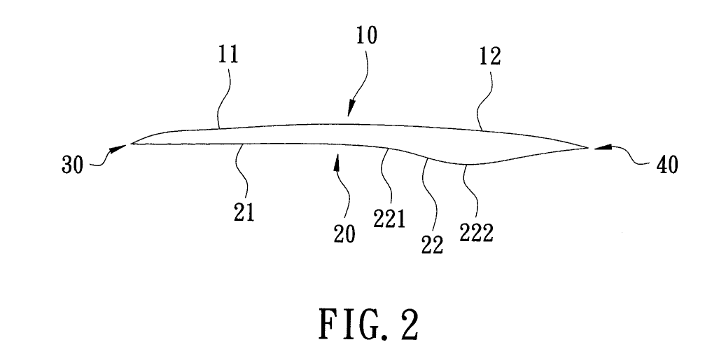

Referring to FIG. 2 showing the advanced foil of the present invention, which provides a ship with adequate lifting force during navigation; the structure thereof mainly comprises:

an upper surface 10 allowing a fluid to smoothly flow from a front 11 toward a rear 12 thereon, so as to efficiently provide the advanced foil with a sufficient lifting force in divergent speeds;

a lower surface 20 combining with the upper surface 10 to form the advanced foil, allowing a fluid to flow from a front of the lower surface 21 toward a rear of the lower surface 22 thereof so as to provide the propeller of the ship with a sufficient lifting force; further, a transitional portion 221 and a curve portion 222 being extended from the rear 22 of the lower surface;

a foil front part 30 formed by the convergence of the fronts of the upper and lower surfaces 10 and 20; and

a foil rear part 40 formed by the convergence of rears of the upper and lower surfaces 10 and 20.

The structure of the advanced foil is formed by the design method of the present invention, which substantially comprises steps of:

Building an advanced foil environment: an environment parameter is set in order to change a pressure distribution of the rear of the lower surface 20 of the advanced foil for the advanced foil being suited to multi speeds so as to avoid a reduction of the efficiency thereof. In addition, the environment parameter further adopts controllable conditions with a turning point of a pressure change as well as a maximum and a minimum values of the pressure distribution of the rear of the lower surface 22 of the advanced foil. Moreover, the upper and lower surfaces 10 and 20 of the fronts of the advanced foil could be automatically adjusted and coordinated according to a lift coefficient (CL). Subsequently, the parameter of the turning point of the pressure change is applied to shape the transitional portion 221 of the advanced foil, and the maximum and the minimum values of the pressure distribution of the rear of the lower surface are applied to form the curve portion 222.

Proceeding an optimization: a constraint to restrict the pressure distribution on the rear of the lower surface is added to a built-environment of the advanced foil. Concurrently, the constraint would be optimized to achieve an advanced foil group that conforms to the lower surface's pressure distribution of the constraint. Wherein, the constraint determines a lift coefficient as a fixed value and achieves an extreme value and a minimum value of a drag coefficient of the advanced foil. In addition, the optimization of the present invention adopts the Lagrange multiplier method.

Analyzing the flow characteristics: each advanced foil of an optimized advanced foil group would be analyzed via flow characteristics under the condition of the advanced foil being applied to divergent speeds, so that a lift coefficient of each advanced foil in the advanced foil group can be achieved.

Building an advanced foil: the advanced foil group analyzed via the flow characteristics continues to process a pressure inverse computation according to the lift coefficient and the environment parameter cooperating with the pressure distribution of a numerical analysis, so that each advanced foil in the advanced foil group would shape a foil profile. Wherein, when the advanced foil is proceeded to the pressure inverse computation, a two dimensional coordinate adopts a B-SPLINE method that previously defines a target profile of the advanced foil before disturbing a control point of said B-SPLINE, so that a profile of the advanced foil that satisfies the pressure distribution of the environment parameter could be accordingly achieved. Further, the B-SPLINE adopts a main scope of four to thirty control points, which essentially adopts twenty-four control points to achieve a preferred effect thereof and avoids a divergent condition.

Calculating the weighting: a built-advanced-foil of the advanced foil group would be proceeded to the weighted calculation under divergent speeds. Wherein, the lift coefficient, the drag coefficient, and Cavitation generated from the advanced foil group being processed are applied to multi speeds, so that the advanced foil group could proceed a weighted calculation according to the proportion thereof being applied in the multi speeds. Accordingly, a best combination of the advanced foil and a corresponding environment parameter combination among the advanced foil group could be selected via the weighted calculation. Wherein, after the advanced foil proceeded to the weighted calculation, a closest value of the environment parameter of the advanced foil would assist the advanced foil being applied to multi speeds, the lift coefficient thereof is not below a target value, and the lift coefficient is nearly close to the target value of the constraint.

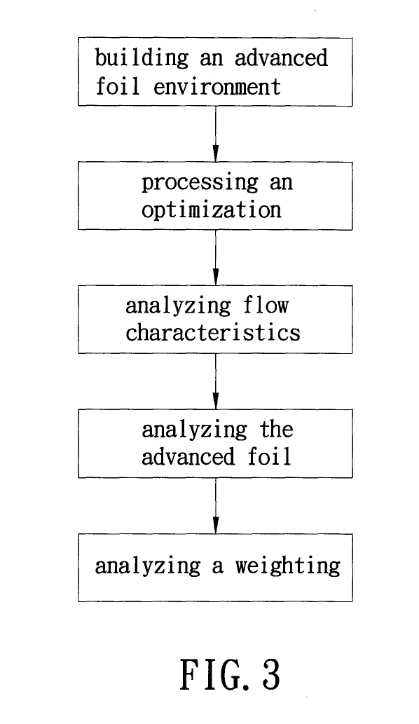

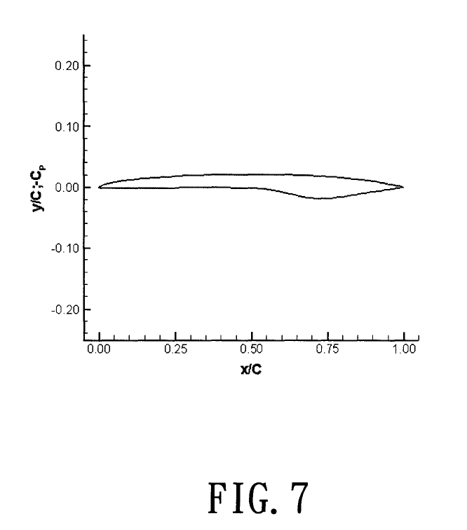

Referring to FIGS. 3 and 7, the advanced foil of the present invention mainly adopts a speed from twenty to forty knots while building the advanced foil environment. Concurrently, the target value of the lift coefficient (CL) of the environment parameter is defined to 0.15 for being operated by the Lagrange multiplier method of the optimization so as to achieve twenty-one kinds of advanced foils that are in conformity with the pressure distribution.

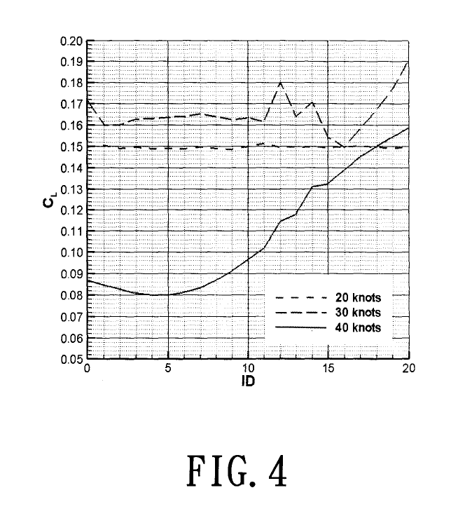

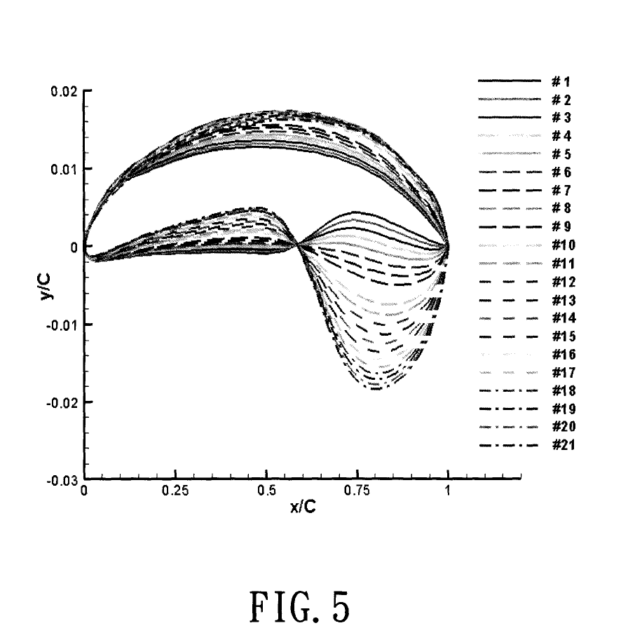

Referring to FIG. 4, the twenty-one kinds of advanced foils are analyzed by the flow characteristics via Computational Fluid Dynamics under the condition the speed of the ship adopts twenty, thirty, and forty knots, respectively, to achieve a lift coefficient value of the advanced foil group. Further referring to FIG. 5, after the advanced foil group being analyzed, the group would continue to process a pressure inverse computation according to the lift coefficient and the environment parameter cooperating with the pressure distribution of a numerical analysis therein, so that each advanced foil in the advanced foil group would shape a foil form.

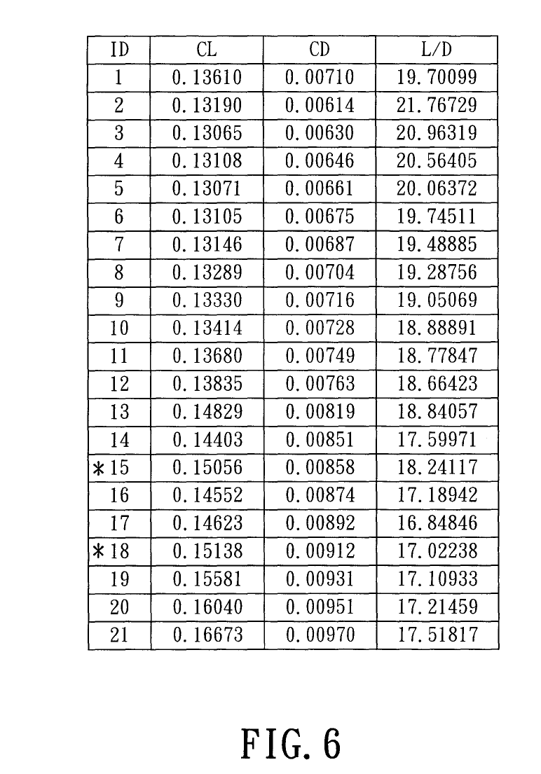

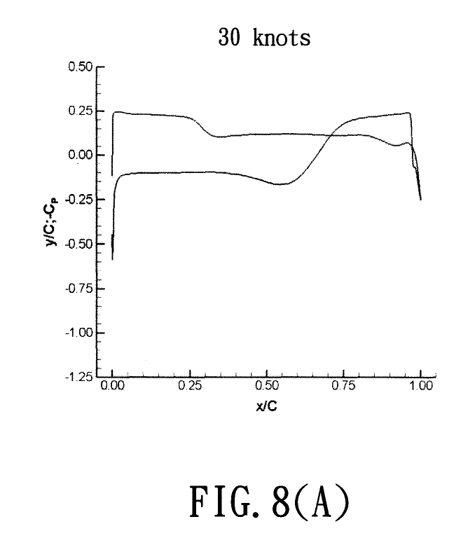

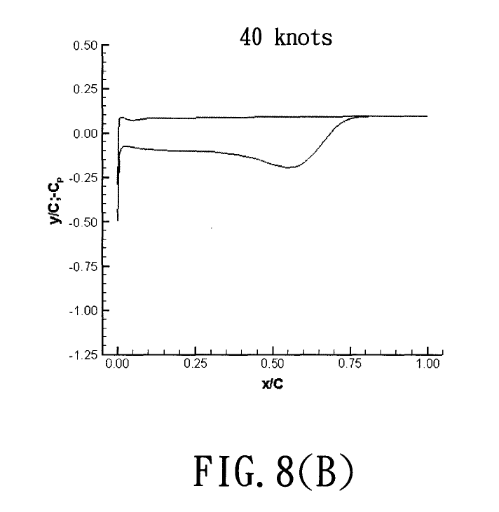

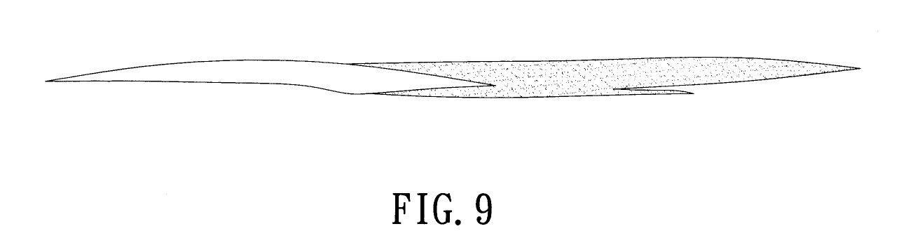

Referring to FIG. 6, since the advanced foil of the present invention is allowably applied to multi speeds in twenty, thirty, and forty knots, a weighted value of each speed is determined to be one third. Whereby, the lift coefficients of No. 15 and No. 18 advanced foils in weighted calculation are found to nearly achieve the preset target value. Namely, their lift coefficients almost equal to the target value 0.15. However, when the speed of the ship achieves forty knots, the lift coefficient of No. 15 advanced foil would be below the target value by 13%, which might be unable to perform a stable efficiency while it is applied to a high speed. Whereas, the lift coefficients of the advanced foil of No. 18 applied to the divergent speeds are not below the target value and approaches the target value. Therefore, the advanced foil of No. 18 is the preferred advanced foil design of the present invention. Further referring to FIGS. 8(A), 8(B), and 9 show the pressure distribution and Caviation analysis of the advanced foil of No. 18 being applied to the speed at thirty and forty knots.

Thus, the present invention favorably achieves the following efficiencies:
1. The advanced foil design method and structure for multi speeds of the present invention provides the advanced foil with the property of the propeller of the Supercavitating series while applied to a high speed and with the strength of the propeller of the NACA and KCA series while applied to a low speed.
2. The advanced foil design method and structure for multi speeds of the present invention provides the advanced foil with a high operative efficiency while applied to a design speed.
3. The advanced foil design method and structure for multi speeds of the present invention takes advantage of the optimization adopting numerical analysis and foil inverse computational techniques for continuing a preferred efficiency in a multiple operational points before building the advanced foil.

The present invention essentially takes the advantages of an improvement and functional application thereof and a similar and alike known prior art are found nowhere. Thus, the present invention is suitable for the patentability.

While we have shown and described the embodiment in accordance with the present invention, it should be clear to those skilled in the art that further embodiments may be made without departing from the scope of the present invention.

I claim:

1. A method for designing advanced foil for multi speeds; said structure of said advanced foil essentially comprising an upper surface and a lower surface; wherein, said design method including steps of:
building an advanced foil environment: an environment parameter being preset in order to change a pressure distribution of a rear of said lower surface of said advanced foil for said advanced foil being suited to multi speeds so as to avoid an overlarge reduction thereof;
processing an optimization: a constraint to restrict said pressure distribution on said rear of said lower surface being added to a built-environment of said advanced foil; said added constraint would be optimized to achieve an advanced foil group that is conforming to said pressure distribution of said constraint of said lower surface of said advanced foil;
analyzing flow characteristics: each advanced foil of an optimized advanced foil group would be analyzed via a method of computational fluid dynamics (CFD) under a condition of said advanced foil being applied to multi speeds to achieve a lift coefficient of each advanced foil in said advanced foil group;
building an advanced foil: said advanced foil group that is analyzed via said flow characteristics would continue to process a pressure inverse computation according to said lift coefficient and said environment parameter cooperating with said pressure distribution of a numerical analysis therein, so that each advanced foil in said advanced foil group would shape a foil form; and
calculating a weighting: a built-advanced-foil of said advanced foil group would be proceeded to said weighted calculation according to a proportion of said advanced foil applied in multi speeds, so that a best profile of an advanced foil and a corresponding environment parameter combination among said advanced foil group could be selected.

2. The design method as claimed in claim 1, wherein, said environment parameter further adopts controllable conditions with a turning point of a pressure change as well as a maximum and a minimum values of said pressure distribution of said rear of said lower surface of said advanced foil; a pressure side of said fronts of said advanced foil could be automatically adjusted and coordinated according to said lift coefficient (CL).

3. The design method as claimed in claim 1, wherein, said constraint determines said lift coefficient to a fixed value for achieving an extreme value of a drag coefficient of said advanced foil.

4. The design method as claimed in claim 3, wherein, a minimum of said drag coefficient of said advanced foil could be achieved.

5. The design method as claimed in claim 3, wherein, after said advanced foil proceeded to said weighted calculation, a best value of said environment parameter of said advanced foil would assist said advanced foil being applied to multi speeds, and said lift coefficient thereof is not below a determined target value.

6. The design method as claimed in claim 3, wherein, during said advanced foil group being proceeded to said weighted calculation, said lift coefficient in said multi speeds that is below a target value of said constraint is previously excluded from said advanced foil group so as to select the rest of foils with lift coefficients of said environment parameter of said advanced foil that approaches said constraint.

7. The design method as claimed in claim 1, wherein, said weighted calculation further adopts Computational Fluid Dynamics (CFD) to proceed a weighted calculation on an efficiency of said multi speeds via said lift coefficient, a drag coefficient, and Cavitation generated from said advanced foil group being applied to multi speeds.

8. The design method as claimed in claim 1, wherein, when said advanced foil is proceeded to said pressure inverse computation, a two dimensional coordinate adopts a B-SPLINE method that previously determines a target profile of said advanced foil before disturbing a control point of said B-SPLINE, so that a profile of said advanced foil that is in conformity with said pressure distribution of said environment parameter can be achieved.

9. The design method as claimed in claim 8, wherein, said B-SPLINE adopts a main scope of four to thirty control points.

10. The design method as claimed in claim 9, wherein, said B-SPLINE adopts twenty-four control points to achieve a preferred effect thereof.

11. A structure of an advanced foil for multi speeds to provide ships with a sufficient lifting force during navigation; said structure of said advanced foil essentially comprising:
an upper surface applied to allow a fluid to smoothly flow on a front of the upper surface toward a rear of the upper surface thereof and provide said advanced foil in each speed with a proper lifting force;
a lower surface combined with said upper surface to form said structure of said advanced foil to allow a fluid to smoothly flow from a front of the lower surface toward a rear of the lower surface thereof and provide a propeller of said ship with a sufficient lifting force;
a foil front part formed by where said fronts of said upper and lower surfaces converge; and
a foil rear part formed by where said rears of said upper and lower surfaces converge.

12. The structure as claimed in claim 11, wherein, a transitional portion and a curve portion are successively extended from said rear toward said foil rear part of said lower surface.
